(19) United States
(12) Patent Application Publication
(10) Pub. No.: US 2005/0278395 A1
(43) Pub. Date: Dec. 15, 2005

(54) Remotely identifying software on remote network nodes by discovering attributes of software files and comparing software file attributes to a unique signature from an audit table

(75) Inventor: Johnny Sandaire, Union, NJ (US)

Correspondence Address: PRIEST & GOLDSTEIN PLLC, 5015 SOUTHPARK DRIVE, SUITE 230, DURHAM, NC, 27713-7736, US

(73) Assignee: Lucent Technologies, Inc., Murray Hill, NJ (US)

(21) Appl. No.: 10/856,482

(22) Filed: May 28, 2004

(51) Int. Cl. G06F 17/30; G06F 12/00; G06F 7/00

(52) U.S. Cl. 707/203

(57) ABSTRACT

Techniques are described for remotely identifying software and software that has been updated due to service patches using maintained audit tables. A system management tool (SMT) identifies software installed on each network node by comparing at a the name and size of installed files to a software audit table. The file name and file size are used as identification markers, and a cyclic redundancy check (CRC) value for a software file, translation key, and version number are used as refined identification markers. A system management tool (SMT) performs an inventory scan of the software on each network node and obtains a list of each file and the corresponding file size. The software audit file provides identifying information, such as the file name and corresponding size, for each known file. Known files can be quickly identified using a match criteria based, for example, on the file name and size. An inventory scan refinement process is also used to further identify software files, including those files that may have been modified due to software patches and may not be discovered by the first level of identifying information.

### CROSS REFERENCE TO RELATED APPLICATIONS

The present invention addresses improvements to U.S. Pat. No. 6,574,729 entitled “System for Remotely Identifying and Providing Information of Unknown Software on Remote Network Node by Comparing the Unknown Software with Software Audit File Maintained on Server” and is related to a commonly owned U.S. patent application Ser. No. ______ entitled “Cleaning and Removing Duplicated Unique Identifiers from Remote Network Nodes” filed contemporaneously herewith, assigned to the assignee of the present invention and incorporated by reference herein in their entirety.

### FIELD OF INVENTION

The present invention relates generally to a distributed computing system, and more particularly to the remote identification, assessment and management of network elements in a distributed computing system.

### BACKGROUND OF THE INVENTION

The resources and computation tasks in a computing system are frequently spread among a plurality of network nodes to form a distributed computing system. When centralized resources are shared by a plurality of users in a distributed system, their costs are distributed over a larger user base. In addition, the centralization of shared resources makes the administration and maintenance of these resources more efficient and also potentially more reliable due to the possibility of a centralized backup mechanism. Furthermore, the redundancy provided by most distributed computing environments improves the ability to recover from a failure by allowing processing tasks to continue on an alternate device upon a detected failure.

While the centralization of shared resources potentially makes the administration and maintenance of network elements more efficient and reliable, the increasing diversity and number of network elements in distributed computing systems provides additional challenges for network management systems that attempt to manage network resources in a uniform manner. In a large network environment, for example, the task of maintaining an inventory of the connected personal computers and workstations, as well as the software installed on each machine, can be daunting.

Thus, a number of automated system management tools are available to remotely inventory computers connected in a network environment. Such system management tools periodically survey each computer and gather hardware and software inventory data by scanning the desktop environment. For example, the System Management Server (SMS™), commercially available from Microsoft Corporation of Redmond, Wash., inventories the computers connected to a network, and the software installed on each computer. The hardware and software inventories generated by the Microsoft SMS tool can be utilized, for example, to identify computers requiring an upgrade or another reconfiguration.

In addition, the hardware and software inventories generated by such system management tools allow known configuration risks, such as a particular virus or a failure to comply with a particular problem, such as the “Year 2000” or “Euro” problems, to be remotely evaluated and remedied or reduced. In this manner, the compliance of each computer with identified risks can be evaluated to determine whether any further remedial work is required.

While such commercially available system management tools assist with the task of obtaining an inventory of hardware and software in a network environment, they suffer from a number of limitations, which if overcome, could greatly expand the utility of such system management tools. For example, in order to inventory the software installed on connected computers, currently available system management tools analyze header information for each executable file on each computer. Thus, to generate a software inventory, such system management tools must analyze voluminous and duplicated data for many computers. Thus, a need exists for an audit file for identifying software and software versions in an efficient manner. A further need exists for methods and apparatus that automatically and efficiently maintain the software audit file.

### SUMMARY OF THE INVENTION

Among its several aspects, one embodiment of the present invention addresses a process for remotely identifying software installed on a remote network node in a distributed computing system. Since the network node is remotely attached to the system, the remote network node is scanned to obtain a list of software files and specific attributes of the software files installed on the remote network node. Upon receiving the results of the scanning operation, a query-based table is updated with the attributes obtained from scanning the remote network node. The process continues with a comparison of the list of software files obtained from scanning the remote network node to a software audit table. New software file entries are created for a final audit table for software files not found in the software audit table.

An inventory scan refinement process further causes the query-based table to be updated with any new software file entries in the final audit table.

Also, among its several aspects, another embodiment of the present invention addresses a method for scanning where entries in a query-based table are marked with trigger marks to indicate missing software file attributes. These trigger marks are used to formulate a request for the missing software file attributes from a remote network node. Next, a request is sent to a remote network node to initiate a scanning operation to obtain missing software file attributes.

A more complete understanding of the present invention, as well as other features and advantages of the invention, will be apparent from the following detailed description and the accompanying drawings.

### BRIEF DESCRIPTION OF DRAWINGS

FIG. 1 illustrates a network environment that interconnects a number of network nodes and a system management tool (SMT) server in accordance with the present invention;

FIG. 2 is a schematic block diagram of an illustrative system management tool (SMT) server of FIG. 1 in accordance with the present invention;

FIG. 3 illustrates an exemplary machine packages database table of FIG. 2 in accordance with the present invention;

FIG. 4A illustrates details of an exemplary query-based table in accordance with the present invention which may suitably be employed as the query-based table of FIG. 2;

FIG. 4B illustrates details of an exemplary discovery table in accordance with the present invention which may suitably be employed as the discovery table of FIG. 2;

FIG. 4C illustrates details of an exemplary software audit table in accordance with the present invention which may suitably be employed as the software audit table of FIG. 2;

FIG. 4D illustrates details of an exemplary final audit table in accordance with the present invention which may suitably be employed as the final audit table of FIG. 2;

FIG. 5 illustrates details of an exemplary unknown software file table in accordance with the present invention which may suitably be employed as the unknown software file table of FIG. 2;

FIG. 6 illustrates details of an exemplary machine identifier table in accordance with the present invention which may suitably be employed as the machine identifier table of FIG. 2;

FIG. 7 illustrates details of an exemplary machine instruction table in accordance with the present invention which may suitably be employed as the machine instruction table of FIG. 2;

FIG. 8 shows a flow chart illustrating an exemplary machine identifier request handling process executed by the system management tool (SMT) server of FIG. 2 in accordance with the present invention;

FIG. 9A shows a flow chart illustrating an exemplary inventory scan results handling process executed by the system management tool (SMT) server of FIG. 2 in accordance with the present invention;

FIG. 9B shows a flow chart illustrating an exemplary inventory scan refinement process executed by the system management tool (SMT) server of FIG. 2 in accordance with the present invention;

FIG. 10 shows a flow chart illustrating an exemplary machine targeted query handling process executed by the system management tool (SMT) server of FIG. 2 in accordance with the present invention; and

FIG. 11 is a flow chart illustrating an exemplary client signature request handling process executed by an SMT client on a network node of FIG. 1 in accordance with the present invention.

### DETAILED DESCRIPTION

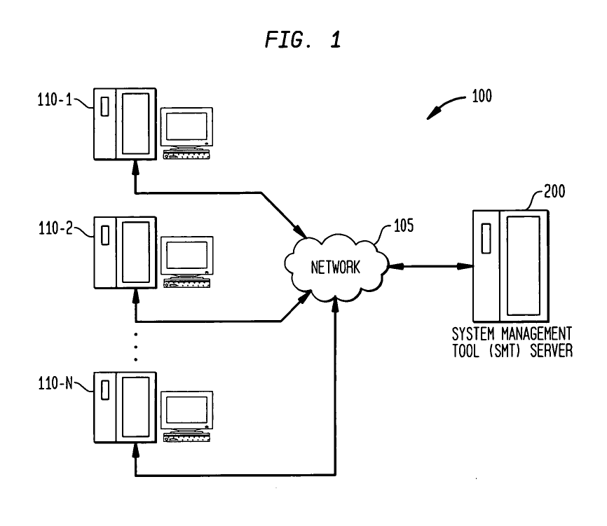

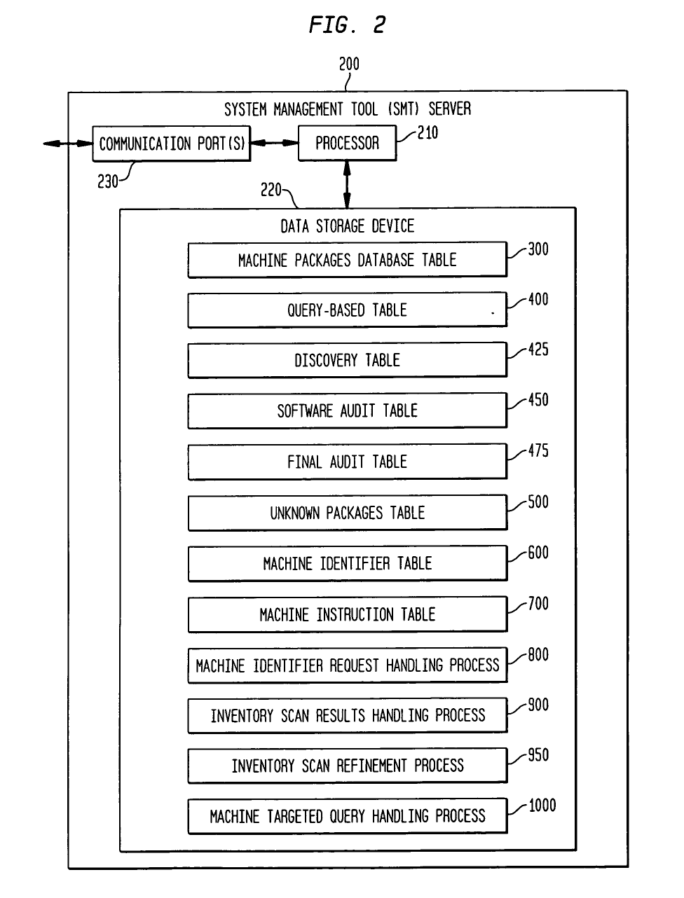

FIG. 1 illustrates a network environment 100 that includes a number of network nodes 110-1 through 110-N (hereinafter, collectively referred to as network nodes 110) and a system management tool (SMT) server 200, containing a server module (SM) for enhanced software package identification, as discussed further below in conjunction with FIGS. 2-11, interconnected by a network 105, such as a local area network (LAN) or a wide area network (WAN). The network nodes 110 may be embodied, for example, as workstations, personal computers, servers or routers and each network node may contain a plurality of software files.

According to a feature of the present invention, the system management tool (SMT) server 200 communicates with each network node 110 to identify the software that is installed on each network node 110 using a software file name and file size as identification markers, a cyclic redundancy check (CRC) value for a software file, a translation key, and a version number as refined identification markers. In one implementation, the system management tool (SMT) server 200 attempts to identify all files having an “.exe,” “.dll” or “.com” extension. While the system management tool (SMT) server 200 identifies software files in the illustrative embodiment, the present invention can be easily extended to collectively identify a collection of files, such as a software application or a software package, as a single unit. For example, if a version of a word processing application is known to contain a collection of predefined files, the collection of predefined files can be identified as the single word processing application.

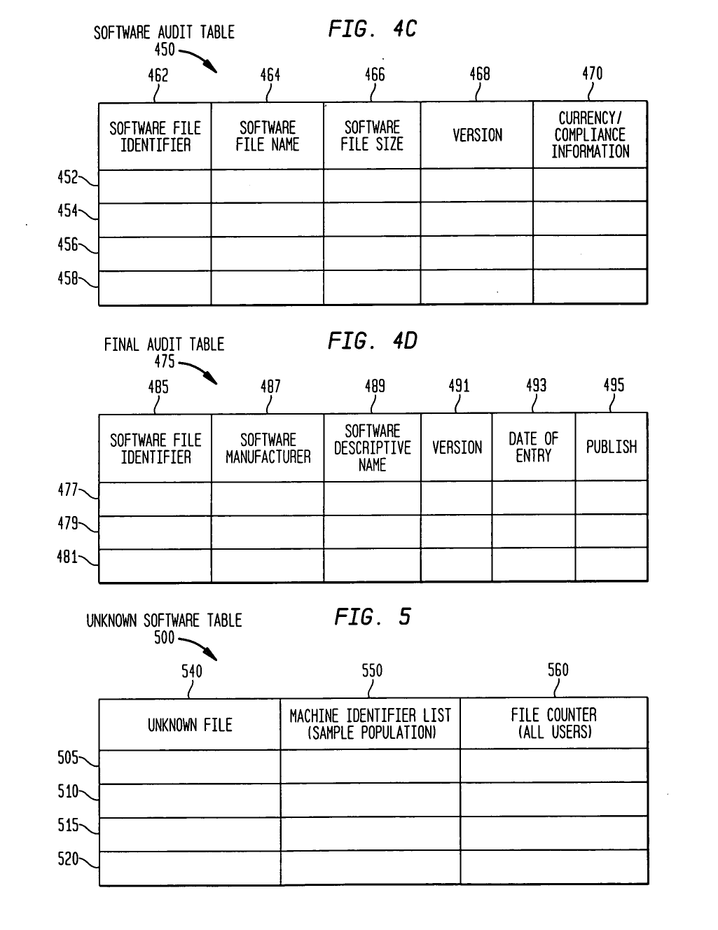

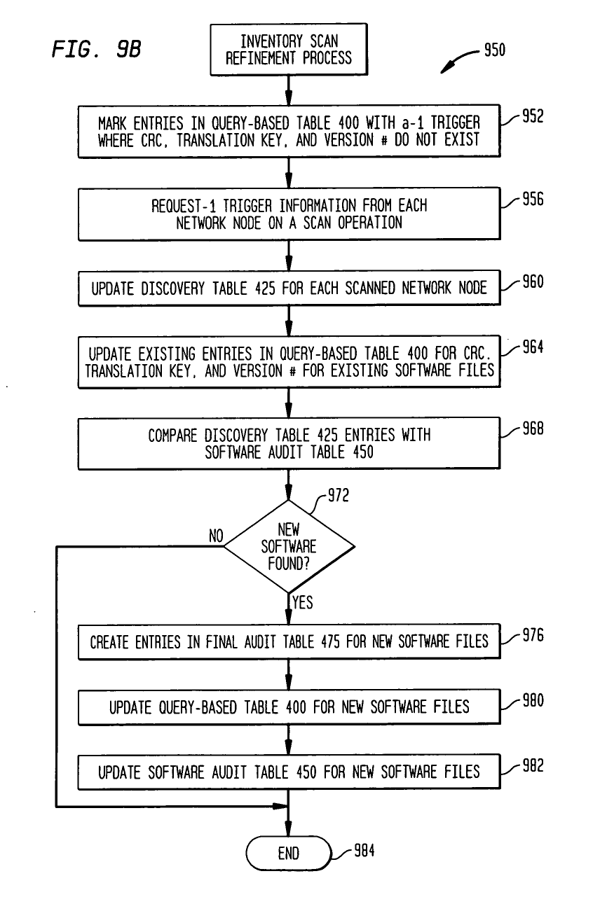

The system management tool (SMT) server 200 performs an inventory scan of the software on each network node 110 and obtains a list of each software file and the corresponding file size. The system management tool (SMT) server 200 also maintains a software audit table 450, discussed below in conjunction with FIG. 4C, that provides a first level of identifying information, such as the file name and corresponding size, for each known file. Thus, by utilizing a match criteria of file name and size, known files can be quickly identified. If an inventory item does not match with an entry in the software audit table 450, then the inventory item is added to an unknown audit file for further research. An inventory scan refinement process, described in more detail below in conjunction with process 950 of FIG. 9B, is also used to further identify software files, including those files that may have been modified due to software patches and may not be discovered by the first level of identifying information.

According to a further feature of the present invention, the software audit file is maintained by investigating an unknown file with a sample of the user population having the unknown file. In one implementation, a targeted query is automatically transmitted to a sample of the user population having the unknown file, requesting header information for the unknown file. In this manner, previously unknown files can be added to the software audit file 450.

According to another feature of the invention, a mechanism is disclosed for quickly identifying a network node 110, such as network node 110-2, in order to retrieve a list of instructions to be executed by the network node 110-2. In the illustrative software audit table maintenance embodiment, a targeted query can be quickly retrieved for a member of the sample user population upon the next log-in to the distributed computing system network environment. In the illustrative embodiment, the targeted query consists of a request to locate a software file, obtain requested information about the file and return the requested information to the system management tool (SMT) server 200. Generally, the present invention permits a fast machine and instruction look-up by storing a machine identifier on each network node 110, that can be used by the system management tool (SMT) server 200. The machine identifier can be quickly reduced to a simple index into an array, thereby permitting the system management tool (SMT) server 200 to identify a particular network node 110 without using a hashing routine. In one implementation, the system management tool (SMT) server 200 stores a client signature on each network node 110 that includes the machine identifier.

FIG. 2 is a schematic block diagram of an illustrative system management tool (SMT) server 200. As shown in FIG. 2, the system management tool (SMT) server 200 includes certain hardware components, such as a processor 210, a data storage device 220, and one or more communications ports 230. The processor 210 can be linked to each of the other listed elements, either by means of a shared data bus, or dedicated connections, as shown in FIG. 2. The communications port(s) 230 allow(s) the system management tool (SMT) server 200 to communicate with the network nodes 110 over the network 105.

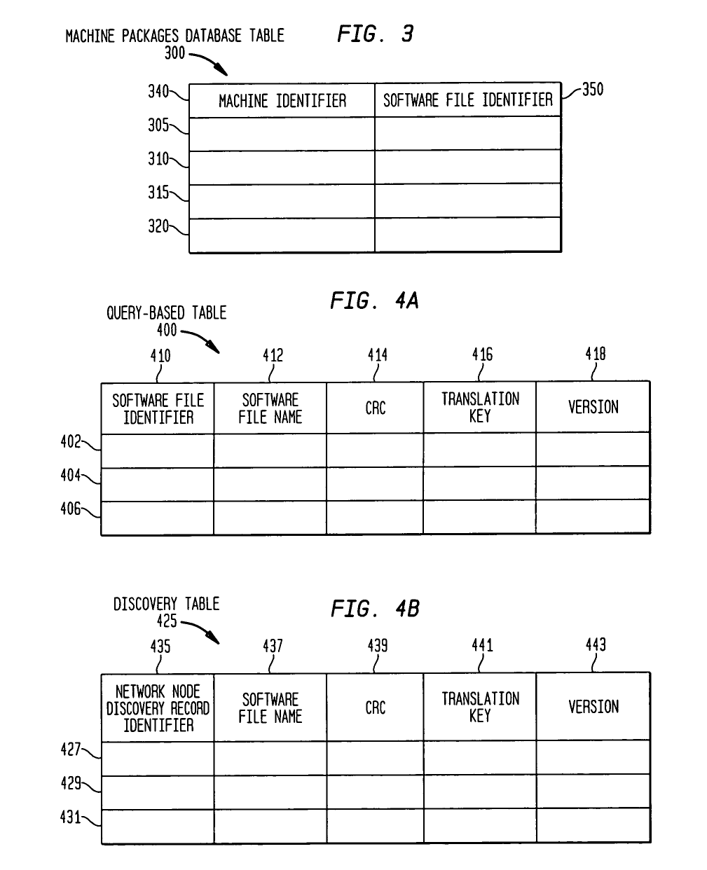

The data storage device 220 is operable to store one or more instructions, discussed further below in conjunction with FIGS. 8-10, which the processor 210 is operable to retrieve, interpret and execute in accordance with the present invention. In addition, as discussed further below in conjunction with FIGS. 3-7, respectively, the data storage device 220 includes a machine packages database table 300, a query-based table 400, a discovery table 425, a software audit table 450, a final audit table 475, an unknown software file table 500, a machine identifier table 600 and a machine instruction table 700. Generally, the machine packages database table 300 identifies the software files or packages that are installed on each network node 110. The query-based table 400 is used as a reference table for triggering processing steps to refine the identification of software files in a system. The discovery table 425 is used to record appropriate discovered data from network node scan operations. The software audit file 450 maintains a list of identifying information for each known software file or package. The final audit table 475 maintains a list of newly identified software files as a result of a discovery identification refinement process. The unknown software file table 500 is a list of the software files or packages that are identified during an inventory scan which are not currently found in the software audit file 450. The machine identifier table 600 contains a list of the machine identifiers assigned by the system management tool (SMT) server 200 and optionally includes additional identifying information for each network node 110, such as a machine name or IP address or both. The machine instruction table 700 contains instructions associated with the targeted queries to identify unknown files for the sample user population.

In addition, the data storage device 220 includes a machine identifier request handling process 800, an inventory scan results handling process 900, an inventory scan refinement process 950, and a machine targeted query handling process 1000. Generally, the machine identifier request handling process 800 is executed by the system management tool (SMT) server 200 to assign machine identifiers to network nodes 110. The inventory scan results handling process 900 processes the list of files generated by a software inventory scan of each network node 110, in a known manner, to identify unknown files for further processing in accordance with the present invention. The inventory scan refinement process 950 picks up variations in software files that may have been modified due to software patches or the like and also identifies new software files. The machine targeted query handling process 1000 retrieves a list of instructions to be executed by a network node 110, for example, to perform a targeted query for a member of the sample user population upon the next log-in.

It is noted that the system management tool (SMT) server 200 may load one or more of the databases/tables 300 through 700 into arrays in the memory of the server 200 for faster access. The machine instruction table 700 can be loaded into an array, for example, sorted in a manner to group the instructions for a given network node 110 together. In addition, an instruction index array (not shown) can be established in memory containing an index of the sorted array from the machine instruction table 700 by machine identifier. The instruction index array can be implemented as a three-dimensional array with three columns as follows: machine identifier, index into the sorted array from the machine instruction table 700 of the first instruction for the network node 110, and index into the sorted array from the machine instruction table 700 of the last instruction for the network node 110.

Assigning Machine Identifiers

When a network node 110, such as network node 110-2, connects to the server 200 for the first time, the network node 110 will request that the server 200 generate a machine identifier. In one preferred embodiment, the machine identifier should be easily reducible to a unique small integer for fast identification, yet distinct enough so that if the server reassigns the same small integer to another machine another mechanism exists for distinguishing the two machines. Thus, in one implementation, the machine identifier consists of two parts, with the first part being a small integer that serves an index into a machine instruction table 700, discussed below, and the second part being a 128 bit guaranteed unique identifier (GUID) that can be dynamically generated, for example, by a UuidCreate remote procedure call (RPC) function.

The small integer portion should always remain close to the range of 0 and the total number of network nodes 110 in the machine identifier table 600, and is assigned in a similar manner to a leased identifier. If the system management tool (SMT) server 200 has not run an inventory scan for a period of time that is greater than a cleaning interval, the lease on the integer portion of the identifier may be lost.

The GUID portion of the machine identifier should remain as a permanent identifier of the network node 110 at least until such a time as it gets lost on the client side as may occur by completely wiping it off of all the machines fixed drives due to a hardware failure, for example. Thus, while the GUID uniquely identifies a network node, it is much faster to lookup instructions for the network node client using a simple integer. Once the cleaning interval has elapsed, if the network node has not been re-inventoried, it is assumed that the network node 110 has been taken out of circulation, and, therefore, it is not necessary to maintain a list of instructions for it. If by chance the network node is re-inventoried after it has lost the assigned lease identifier on the small integer portion of the machine identifier, a new lease identifier can be assigned, but the GUID portion of the machine identifier continues to remain the same. The advantage of this approach is a very quick lookup of instructions for the network nodes, and a guaranteed unique permanent identifier.

Storage of Client Signatures

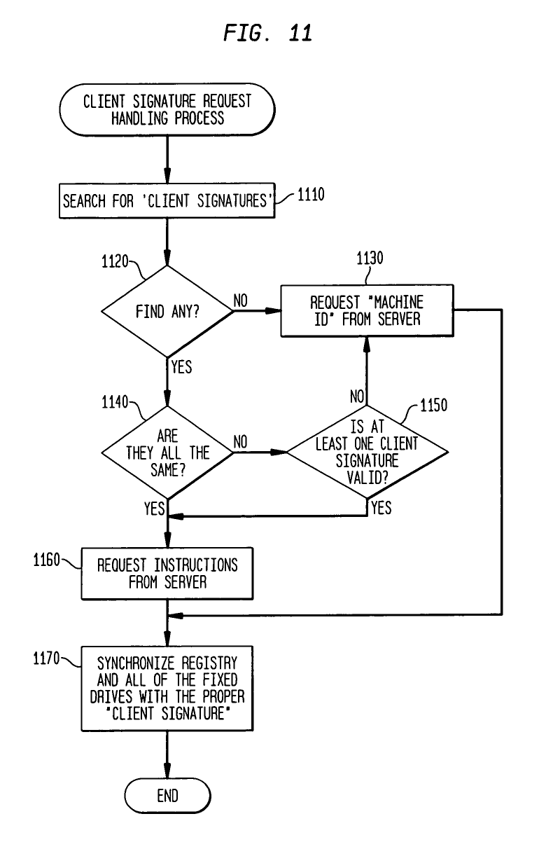

The machine identifier received by the network node 110 from the server 200 is stored in a near permanent place on the network node 110. In addition to the machine identifier, the network node 110 may also store additional information, such as machine ownership, machine usage, or a more detailed machine identification, collectively referred to as a client signature. In one implementation, the machine identifier is stored in a client signature in the registry of the network node 110, and as a hidden file on each of the fixed drives of the network node 110 for redundancy. The client signature can also include a “client side identifier” for the network node 110 such as the NIC card address, the serial number, or a BIOS Signature. During an inventory scan of a particular network node 110, the SMT client looks for the client signature in the registry, and all of the fixed drives of that particular network node 110. As discussed below in conjunction with FIG. 11, the SMT client will perform a number of predefined actions, depending on where and how many client signatures are found on the network node 110.

FIG. 3 illustrates an exemplary machine packages database table 300 that identifies the software files or packages that are installed on each network node 110. The machine packages database table 300 identifies a particular network node 110 using a machine identifier (or serial number), and identifies the software files installed on the network node 110 using a software file identifier that is unique for each different software file in the inventoried system. The machine packages database table 300 maintains a plurality of records, such as records 305, 310, 315, and 320, each corresponding to a different network node 110. For each network node 110 identified by a machine identifier in field 340, the machine packages database table 300 indicates the installed software files on the network node 110 in field 350. The software file identifiers used in field 350 can be used to access a software audit table 450, discussed below, to obtain more detailed information about the software file.

FIG. 4A illustrates an exemplary query-based table 400 that is used as a reference table for triggering processing steps to refine the identification of software files in the inventoried system. The query-based table 400 contains a plurality of records, such as records 402, 404, and 406, with each record containing a software file identifier 410 that uniquely identifies the software file, a software file name 412, such as winword.exe, for example, a CRC entry 414 for representing the CRC value at the time of the scan, a translation key 416 for representing how the software file may be used, for example, specifying the language used, and a version number 418.

FIG. 4B illustrates an exemplary discovery table 425 that is used to record appropriate discovered data from network node scan operations. For example, the discovery table 425 contains a plurality of records, such as records 427, 429, and 431, with each record containing a network node discovery record identifier 435, that uniquely identifies the network node and scan record, a software file name 437 using the same name for a discovered software file as may be found in the query-based table software file name 412, a CRC entry 439, a translation key 441, and a version number 443.

FIG. 4C illustrates an exemplary software audit table 450 that maintains a list of identifying information for each known software file or package. The software audit table 450 identifies a particular software file (or collection of files) using a software file identifier, and identifies properties of each corresponding software file. The software audit table 450 maintains a plurality of records, such as records 452, 454, 456, and 458, each corresponding to a different software file (or package). For each software file (or collection of files) identified by a software file identifier in field 462, the software audit file 450 indicates the name of the file (or software application or software package) and the corresponding size in fields 464 and 466, respectively. As previously indicated, the file name and file size properties are used as identification markers for known software files in the illustrative embodiment. In addition, for each software file (or collection of files), the software audit table 450 provides the version number in field 468, and indicates any desired currency or compliance information in field 470. For example, the compliance of each computer with identified risks, such as security risks of software viruses, can be evaluated to determine whether any further remedial work is required FIG. 4D illustrates an exemplary final audit table 475 that maintains a list of newly identified software files as a result of a discovery identification refinement process. The final audit table 475 contains a plurality of records, such as records 477, 479, and 481, with each record containing a software file identifier 485 that is uniquely created for any newly discovered software files. Associated with the software file identifier 485 are entries for a software manufacturer 487, such as Microsoft Corporation, a software descriptive name 489, such as Microsoft® Word, a version number 491, a date the entry was created 493, and a publish indicator 495 to indicate whether or not to publish the software file.

FIG. 5 illustrates an exemplary unknown software file table 500 that maintains a list of the software files or packages that are identified during an inventory scan but are not currently found in the software audit table 450. As previously indicated, the present invention flags such unknown files for further processing so that they can be added to the software audit table 450, once they are identified. In this aspect, the present invention maintains the software audit table 450. The unknown software file table 500 identifies a particular unknown software file using information obtained during the inventory scan, such as a file name, and contains a list identifying the network nodes 110 upon which the unknown file is installed. The unknown software file table 500 maintains a plurality of records, such as records 505, 510, 515, and 520, each corresponding to a different unknown software file. For each unknown software file identified in field 540, the unknown software file table 500 contains a list identifying the network nodes 110 in the sample population upon which the unknown file is installed in field 550. In addition, the unknown software file table 500 contains a file counter in field 560 that tracks the total number of network nodes 110 upon which the unknown file is installed in field 550. Thus, the counter in field 560 tracks the extent of the distribution of the unknown file, and unknown files with a higher distribution can be given a higher priority for further investigation.

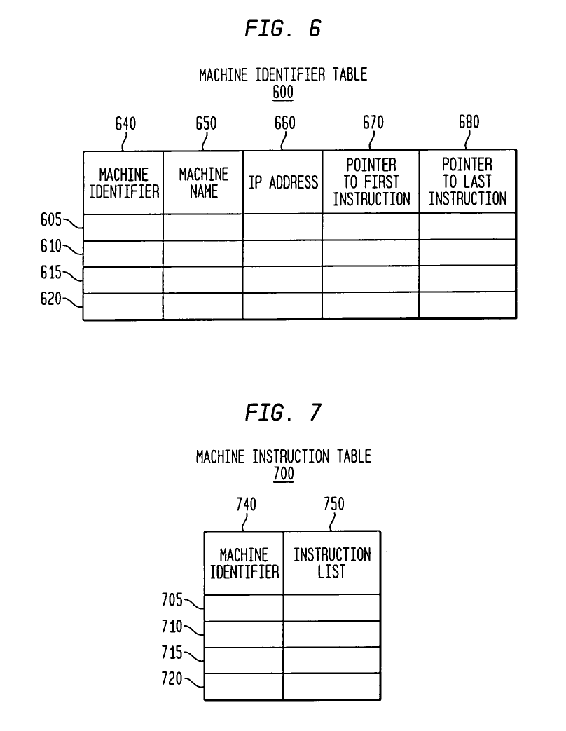

FIG. 6 illustrates an exemplary machine identifier table 600 that maintains a list of the machine identifiers assigned to network nodes 110 by the system management tool (SMT) server 200 and optionally includes additional identifying information for each network node 110, such as a machine name or IP address or both. The machine identifier table 600 maintains a plurality of records, such as records 605, 610, 615, and 620, each corresponding to a different network node 110. For each network node 110 identified by a machine identifier in field 640, the machine identifier table 600 indicates the name of the network node 110 and the IP address of the network node 110 in fields 650 and 660, respectively. In addition, in one implementation, the machine identifier table 600 contains pointers to the first and last targeted instruction in the machine instruction table 700 associated with the network node 110 in fields 670 and 680, respectively. As previously indicated, the pointer may actually point to an instruction array stored in the memory of the system management tool (SMT) server 200, as opposed to the machine instruction table 700 stored in a database.

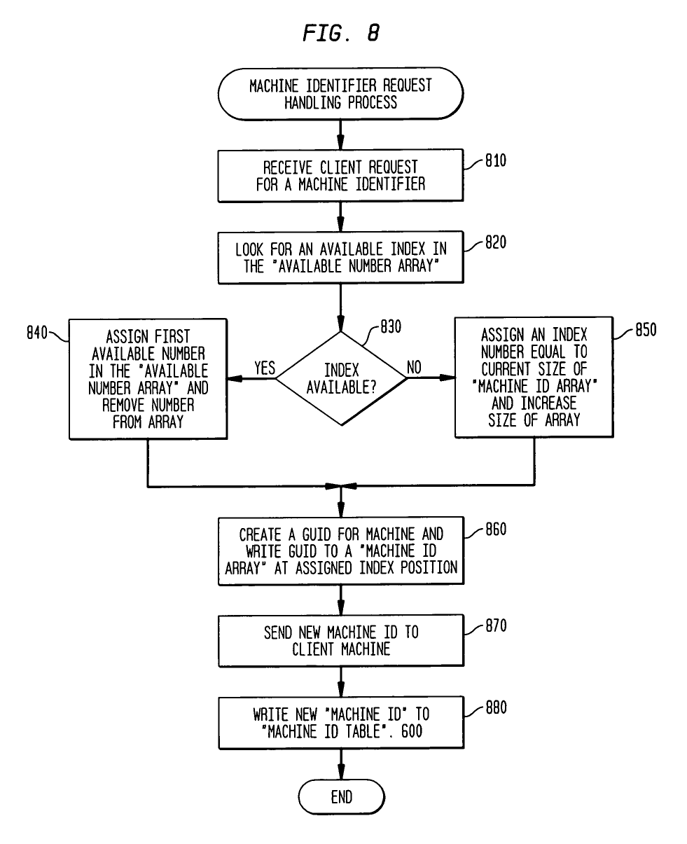

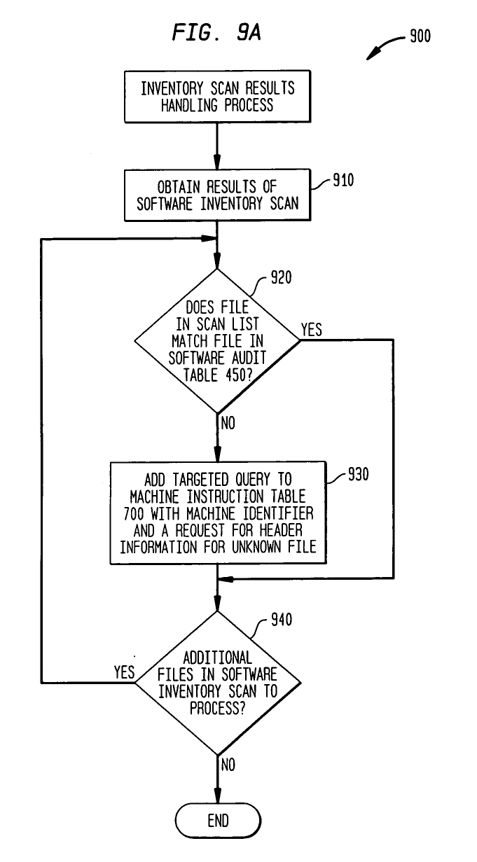

FIG. 7 illustrates an exemplary machine instruction table 700 that maintains instructions associated with the targeted queries to identify unknown files for the sample user population. The machine instruction table 700 maintains a plurality of records, such as records 705, 710, 715, and 720, each corresponding to a different instruction. For each instruction indicated in field 750, the associated network node 110 is indicated in field 740. The machine identifier indicated in field 740 of the machine instruction table 700 should be the integer portion of the server generated machine identifier from the machine identifier table 600. The instruction field 750 can be a text type so that the field can hold instructions that are greater than 255 characters long. In one embodiment, the machine instruction table 700 can be sorted using the machine identifier field 740 such that instructions for the same network node 110 are grouped together.

SMT Server Processes

As previously indicated, the system management tool (SMT) server 200 performs a machine identifier request handling process 800, shown in FIG. 8, to assign machine identifiers to network nodes 110. As shown in FIG. 8, the machine identifier request handling process 800 is initiated upon receipt of a request from an SMT client for a machine identifier during step 810. The system management tool (SMT) server 200 then looks for an available index (machine identifier) in an available number array during step 820.

A test is performed during step 830 to determine if an index is available. If it is determined during step 830 that an index is available, then the first available number is assigned to the network node 110 during step 840 and the assigned number is removed from the available number array. If, however, it is determined during step 830 that an index is not available, then an index number is assigned during step 850 equal to the current size of the machine identifier array and the size of the machine identifier array is incremented.

A guaranteed unique identifier (GUID) is created for the network node 110 during step 860 and the GUID is written to the machine identifier array at the assigned index position. The system management tool (SMT) server 200 transmits the machine identifier to the network node 110 during step 870 and writes the machine identifier to the machine identifier table 600 during step 880, before program control terminates.

As previously indicated, the system management tool (SMT) server 200 executes an inventory scan results handling process 900, shown in FIG. 9A, to process the list of files generated by a software inventory scan of each network node 110, in a known manner, and to identify unknown files for further processing in accordance with the present invention. As shown in FIG. 9A, the inventory scan results handling process 900 initially obtains the results of a software inventory scan during step 910, for example, from a commercially available software management tool, such as the System Management Server (SMS)™, commercially available from Microsoft Corporation.

A test is performed during step 920 to determine if a file in the inventory scan list matches the file information in the software audit table 450. If it is determined during step 920 that a file in the inventory scan list matches the file information in the software audit table 450 (for example, based on file name and file size), then the software file being processed has been previously identified and program control proceeds to step 940 to process the next file in the inventory scan list.

If, however, it is determined during step 920 that a file in the inventory scan list does not match the file information in the software audit table 450 (for example, based on file name and file size), then a targeted query is added to the machine instruction table 700 during step 930 containing a machine identifier for the network node 110 where the file was found and a request for header information for the unknown file.

A test is performed during step 940 to determine if additional files in the software inventory scan list must be processed. If it is determined during step 940 that additional files exist, then program control returns to step 920 to process the next file and processing continues in the manner described above. If, however, it is determined during step 940 that additional files do not exist in the inventory list, then program control terminates. In this manner, the inventory scan results handling process 900 generates an instruction for each unknown file that is found on any network node 110.

As a system evolves over time, existing registered software files on various network node machines may typically be updated with a service package or patch so that proper identification of these different software files may become difficult if not impossible by using only file name and file size metrics. Consequently, a refined inventory scan process according to one aspect of the present invention can be utilized on an existing inventory asset management system to pick up these variations and be used as part of a normal scan process to also identify new software files. FIG. 9B illustrates one such advantageous inventory scan refinement process 950. Beginning in step 952, a query-based table, such as query-based table 400, is used for triggering processing steps to refine the identification of software files in a system. If existing registered software files are lacking an entry, such as a CRC entry 414, a translation key 416, or a version number 418, then the missing entry is marked with a trigger indicator, such as a value of (−1). In step 956, the server, such as server 200, requests a scan operation of network nodes to obtain the marked information. Upon collecting the scan information, a discovery table 425 is updated in step 960 with the requested information. In step 964, the missing entries in the query-based table 400 for a software file can now be updated using the data from the discovery table 425. In step 968, the discovery table 425 is compared to the software audit file 450 to determine if any new software files were discovered. If new software files were found, a decision is made in step 972 to record the newly discovered software files by proceeding to step 976. In step 976, the new software files are added to a final audit table 475. Using the final audit table 475, the query-based table 400 is updated in step 980 for the newly discovered software files and the process 950 then proceeds to ending point 984. The software audit table is updated in step 982 to reflect the newly discovered software files. Returning to step 972, if no new software files were discovered, as a result of the compare step 968, then process 950 proceeds to ending point 984.

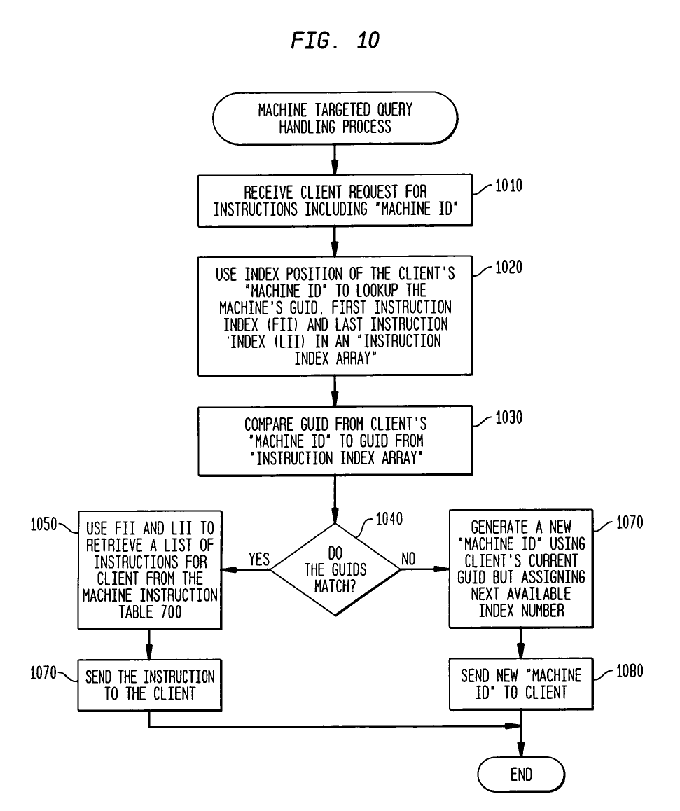

As previously indicated, the system management tool (SMT) server 200 executes a machine targeted query handling process 1000, shown in FIG. 10, to retrieve a list of instructions to be executed by a network node 110, for example, to perform a targeted query for a member of the sample user population upon the next log-in. The machine targeted query handling process 1000 can be executed, for example, upon each log-in by a network node 110 to the system management tool (SMT) server 200. As shown in FIG. 10, the machine targeted query handling process 1000 is initiated during step 1010 upon receiving a request from an SMT client for any instructions to be executed. The request generally includes a machine identifier of the network node 110.

The system management tool (SMT) server 200 uses the index portion of the machine identifier during step 1020 to look up the GUID of the network node 110, as well as a first instruction index (FII) (from field 670 of the machine identifier table 600) and a last instruction index (LII) (from field 680 of the machine identifier table 600) in the instruction index array. Thereafter, the system management tool (SMT) server 200 compares the GUID from the machine identifier of the network node 110 during step 1030 to the corresponding GUID from the instruction index array.

A test is performed during step 1040 to determine if the GUIDs match. If it is determined during step 1040 that the GUIDs do match, then the first instruction index (FII) and the last instruction index (LII) are used to retrieve the list of instructions for the network node 110 from the machine instruction table 700. Alternatively, a corresponding array may be loaded into memory. The system management tool (SMT) server 200 then transmits the instruction list to the network node 110 during step 1060, before program control terminates during step 1090.

If, however, it is determined during step 1040 that the GUIDs do not match, then a new machine identifier is generated during step 1070, using the current GUID of the network node 110, but assigning the next available index number. The new machine identifier is then transmitted to the network node 110 during step 1080 before program control terminates during step 1090.

SMT Client Process

The SMT client executing on a network node 110 executes a client signature request handling process 1100, shown in FIG. 11, to handle requests from the system management tool (SMT) server 200 for a client signature. As shown in FIG. 11, the client signature request handling process 1100 initially searches for the client signature during step 1110.

A test is performed during step 1120 to determine if any client signatures are identified. If it is determined during step 1120 that client signatures do exist on the network node 110, then a further test is performed during step 1140 to determine if the identified client signatures are all the same. If, however, it is determined during step 1120 that client signatures do not exist on the network node 110, then the SMT client requests a machine identifier from the system management tool (SMT) server 200 during step 1130 and then program control proceeds to step 1170, discussed below.

If it is determined during step 1140 that the identified client signatures are all the same, then the SMT client uses the machine identifier contained in the client signature to obtain instructions from the server during step 1160. If, however, it is determined during step 1140 that the identified client signatures are not all the same, then a further test is performed during step 1150 to determine if at least one of the client signatures are valid. If it is determined during step 1150 that none of the identified client signatures are valid, then program control proceeds to step 1130 and continues in the manner described above. If, however, it is determined during step 1150 that at least one of the identified client signatures is valid, then program control proceeds to step 1160 and continues in the manner described above.

The SMT client synchronizes the registry and fixed drives with the proper client signature during step 1170, before program control terminates.

It is to be understood that the embodiments and variations shown and described herein are merely illustrative of the principles of this invention and that various modifications may be implemented by those skilled in the art without departing from the scope and spirit of the invention.

1. A method for remotely identifying software installed on a remote network node in a distributed computing system, the method comprising:
scanning a remote network node to obtain a list of software files and specific attributes of the software files installed on the remote network node;
updating a query-based table with the attributes obtained from scanning the remote network node;
comparing the list of software files obtained from scanning the remote network node to a software audit table; and
creating new software file entries for a final audit table for software files not found in the software audit table.

2. The method of claim 1 wherein the query-based table is updated with the new software file entries for the final audit table.

3. The method of claim 1 wherein scanning further comprises:
marking entries in a query-based table with trigger marks indicate missing software file attributes;
formulating a request, based on the trigger marks, for the missing software file attributes from a remote network node; and
sending a request to a remote network node to initiate a scanning operation to obtain the missing software file attributes.

4. The method of claim 1 wherein the specific attributes of the software files include a software file name and a cyclic redundancy check (CRC) value.

5. The method of claim 1 wherein the specific attributes of the software files include a translation key and a version number.

6. The method of claim 1 wherein the query-based table comprises:
a software file identifier;
a software file name; and
a cyclic redundancy check (CRC) value.

7. The method of claim 1 wherein the query-based table further comprises:
a translation key; and
a version number.

8. The method of claim 1 wherein the list of software files and specific attributes of the software files are entered into a discovery table.

9. The method of claim 8 wherein the discovery table comprises:
a network node discovered record identifier;
a software file name; and
a cyclic redundancy check (CRC) value.

10. The method of claim 9 wherein the discovery table further comprises:
a translation key; and
a version number.

11. The method of claim 1 wherein the software audit table comprises:
a software file identifier;
a software file name; and
a software file size.

12. The method of claim 11 wherein the software audit table further comprises:
a version number; and
risk compliance information.

13. The method of claim 1 wherein the final audit table comprises:
a software file identifier;
a name of a software file manufacturer;
a software descriptive name; and
a version number.

14. The method of claim 13 wherein the final audit table further comprises:
a date of entry for a record in the final audit table; and
an indication of whether to publish or not.

15. A system for remotely identifying software installed on a remote network node in a distributed computing environment, the system comprising:
a memory for storing a query-based table, a software file table, and a final audit table;
a processor operatively coupled to the memory and configured to:
scan a remote network node to obtain a list of software files and specific attributes of the software files installed on the remote network node;
update a query-based table with the attributes obtained from scanning the remote network node;
compare the list of software files obtained from scanning the remote network node to a software audit table; and
create new software file entries for a final audit table for software files not found in the software audit table.

16. A computer-readable medium whose contents cause a computer system to perform a method for remotely identifying software installed on a remote network node in a distributed computing system, by performing the steps of:
scanning a remote network node to obtain a list of software files and specific attributes of the software files installed on the remote network node;
updating a query-based table with the attributes obtained from scanning the remote network node;
comparing the list of software files obtained from scanning the remote network node to a software audit table; and
creating new software file entries for a final audit table for software files not found in the software audit table.

17. The computer-readable medium of claim 16 wherein the query-based table is updated with the new software file entries for the final audit table.

18. The computer-readable medium of claim 16 wherein scanning further comprises the steps of:
marking entries in a query-based table with trigger marks indicating missing software file attributes;
formulating a request, based on the trigger marks, for the missing software file attributes from a remote network node; and
sending a request to a remote network node to initiate a scanning operation to obtain the missing software file attributes.
